(19) United States
(12) Patent Application Publication
(10) Pub. No.: US 2026/0074351 A1
(43) Pub. Date: Mar. 12, 2026

(54) HONEYCOMB-LIKE THERMAL INSULATION FOR BATTERY ARRAYS

(71) Applicant: Soteria Battery Innovation Group, Inc., Greenville, SC (US)

(72) Inventors: Brian G. Morin, Greenville, SC (US); Ashwin M. Pitts, Greenville, SC (US); Lochan Chitnis, Greenville, SC (US)

(21) Appl. No.: 18/829,525

(22) Filed: Sep. 10, 2024

(51) Int. Cl. H01M 50/291; H01M 10/658; H01M 50/213; H01M 50/293

(52) U.S. Cl. CPC H01M 50/291; H01M 10/658; H01M 50/213; H01M 50/293

(57) ABSTRACT

A battery array insulating and separating structure for implementation with multiple lithium-ion cells is disclosed. Such an article is configured in a manner to permit the disposition of individual batteries in close proximity to one another while simultaneously being separated from any contact with an insulating material therebetween. The configuration is a honeycomb-like structure preventing any contact between batteries placed therein as well as protection from heat transfer from one battery to another therein. Such a separating/insulating article thus allows for safer utilization of multiple battery cells within a close-quarter array thereof, ostensibly preventing or at least significantly reducing the propensity of a single (or multiple) battery subject to a short or other damaging phenomenon from deleteriously affecting any other batteries within the array through such heat transfer possibilities. A method of utilizing such a unique honeycomb-like array with multiple separate battery cells simultaneously is also encompassed within this disclosure.

### FIELD OF THE DISCLOSURE

Disclosed herein is a unique battery array insulating and separating structure for implementation with multiple lithium-ion cells. Such an article is configured in a manner to permit individual batteries to be disposed evenly in close proximity to one another while simultaneously being separated from any contact with an insulating material therebetween. In one embodiment, the configuration is a polygonal honeycomb-like structure, preferably hexagonal, that prevents any contact between batteries placed therein as well as protection from heat transfer from one battery to another therein. Such a separating/insulating article thus allows for safer utilization of multiple battery cells within a close-quarter array thereof, ostensibly preventing or at least significantly reducing the propensity of a single (or multiple) battery subject to a short or other damaging phenomenon from deleteriously affecting any other batteries within the array through such heat transfer possibilities. A method of utilizing such a unique tessellation arrangement in a honeycomb-like array with multiple separate battery cells simultaneously is also encompassed within this disclosure.

### BACKGROUND OF THE PRIOR ART

Lithium-ion batteries have proven to be of enormous importance as the utilization of electrical devices, from phones to vehicles and further, has grown and continues to grow. In the transportation area, in particular, the capability of such lithium-based electrical generating batteries has led to more widespread adoption and utilization of electrical vehicles throughout the world. The high energy-density, durability, and reasonable cost of such lithium-ion batteries have contributed to such increased usage, certainly; however there remain significant concerns with such large-scale and, again, growing, lithium-ion battery technology. For example, the need for multiple lithium-ion cells to provide sufficient power within electrical vehicles has posed a significant quandary in terms of safety as the potential for short circuiting (due to any number of situations, including, for example, manufacturing issues, battery punctures during use, even dendritic formations within battery separators) in even a single cell may lead to thermal runaway events throughout the entire bank. Micromobility devices, including e-bikes, also have shown to have significant issues with catching fire and propagating, amounting to hundreds of such fires each year in major cities around the globe. Additionally, such large-size arrays require necessarily evenly spaced batteries therein for effective power generation and recharging capabilities, not to mention construction and manufacturing efficiencies in terms of providing the most number of batteries within the smallest overall space (and particularly as it concerns certain battery sizes uniform throughout such an array) as well as improved quick production with easy-to-place batteries in such multiple-structure arrays. Certainly, although electric vehicle battery arrays are quite prominent and thus in need of such structural improvements, other types of devices and vehicles (appliances, electric bicycles, etc.) utilize such lithium-ion battery arrays and thus may need such improvements as well.

Currently, such battery arrays typically are placed on bases with indentations in place complementary in shape to such individual battery cells, allowing for creation of such arrays with such spaced cells. Such bases, however, merely provide spacing of such batteries at the bottom ends (or possibly the top ends, as well) thereof, leaving the batteries themselves without any separating material over the entirety of each cell, thus failing to actually insulate such batteries from one another during utilization. Thus, as alluded to above, an electrical short or like event within a single cell of such a typical array may cause thermal runaway to adjacent cells, causing a domino effect of such problems throughout the entire bank of cells. Such problems actually occur too frequently nowadays within numerous electric vehicles (cars, bikes, and the like, at least). Thus, a definite and desirable need for effective improvements in this area is present. To date, however, there has been nothing to provide a thermally insulating protective article for implementation within such lithium-ion battery arrays.

Additionally, there is often a need to equalize the temperature in an array of batteries in order to keep a single cell from overheating, and also to mitigate the deleterious effects of overheating on cycle life, electrical performance, and the like. Thus, there is a continual need for passive cooling, in which thermal conductors are placed in contact with the individual batteries and also with a thermally conductive path to a heat sink, enabling a pathway to remove heat continually from the batteries, making it more difficult for a single battery to go into thermal runaway.

Optimizing long-term lithium-ion battery device usage would be of great help in this area. To date, however, such life cycle improvements have focused primarily on deficient if not complex and costly modifications, all of which impart questionable benefits. For instance, there has been suggested the utilization of a base honeycomb-like structure of two end plates to provide top and bottom bases for placement of certain cells within an array. However, in such a scenario, there is no placement of any battery cells within an actual honeycomb-like structure itself. Additionally, there are certain configurations that include a buffering heat insulation cooling plate for an array, with an insulating layer placed on top or bottom of a battery back with a hole pattern between such a cooling plate and insulating layer, not the placement of batteries within a fully separated structure. Other developments have suggested the provision of a battery array with expanding material coating individual cells to provide insulation properties therebetween. The problems inherent with all such alternatives are that the battery cells are not definitively kept equidistant from one another, initially, movement of such cells may thus damage any separating materials (such as expanding foams, for example) and cracking of such materials, let alone the dependence on top or bottom insulating articles, clearly lack reliable heat and/or electrical charge protections between individual cells. Further suggested methods include the individually wrapping of cells with certain polymeric films, sheets, or tubes (polyethylene, polypropylene, etc.), wrapping of cells with flame retardant paper sheets or tubes, utilizing silicon rubber, mica, or thermally insulating foam sheets around such cells, or, as alluded to above, injecting foams or plastics around individual cells for protections. Such wrapped cells may lack uniformity of protection, not to mention may be easily manipulated and/or moved from around such cells during use, thereby exhibiting susceptibility to thermal phenomena. Mica may be brittle, as can be injected foams or plastics, requiring either heavy structures that compromise certain benefits of battery cells themselves within certain end use products, or such materials may be harmed by typical activities and thus may be marred or distorted during use and irreparable as a result. Silicon rubber may be extremely expensive, as well.

A simpler, cost-effective, and more reliable approach to thermal protection concerns would be beneficial, certainly, within the battery array industry; however, there is nothing taught within the pertinent art to date that allows for full thermal protections coupled with facilitated manufacture. There thus exists a significant need for a simplified and cost-effective manner of providing such a focus on increasing the useful life of such lithium-ion batteries (particularly within electrical vehicles) as well as ensure individual cells do not cause thermal runaway events throughout the entirety thereof. The disclosure herein provides a suitable solution.

### Advantages and Summary of the Disclosure

A distinct advantage of the present disclosure is the facilitation of the placement of an array of batteries within a single structure equidistant from one another within a geometrically configured article. Another distinct advantage is the ability of such a geometrically configured article to fully separate each individual battery within such an array through the presence of a thermally insulting material in solid form. Yet another advantage of the disclosed geometrically configured article and array included therein is the ability to quickly arrange and place such individual batteries manually for reduced propensity for human manufacturing errors as well as permitting decreased complexity for robotic manufacturing operations. Yet another advantage is the provision of optimal thermal runaway protections through the utilization of such thermally insulating materials within the geometrically configured article through complete separation of individual batteries within the subject array as well as equivalent levels of thermal insulation for each such battery therein. Yet another advantage is to provide thermally conductive pathways to remove heat (passive cooling) while also providing mechanical and thermal separation between the cells. Yet another advantage is to provide material that absorbs and buffers shock, vibration and other mechanical damage to an array of batteries to reduce the probability of a mechanically induced thermal runaway event.

Accordingly, this disclosure pertains in one embodiment to a thermally insulating article configured in a polygonal, preferably as a regular polygon or honeycomb-like shape, comprising individual cells therein that exhibit geometric symmetry in relation to one another in a repeating structure and that each exhibit wall formations therein of a uniform height and distance from one another; wherein said thermally insulating article provides a plurality of individual cells for introduction of individual batteries within each individual cell to create an array of such individual batteries thereof, wherein each individual cell exhibits a size and shape in relation to the shape and size of an individual battery within said array such that such a battery placed therein is not in contact with or directly adjacent to another battery within said array, and wherein said individual cell wall formations are comprised of thermally insulating materials exhibiting mechanical resiliency and flexibility to ensure no appreciable damage occurs thereto said thermally insulating article during use thereof. Such a thermally insulating article thus accords an overall structure allowing for proper cell spacing of the gaps in the honeycomb-like structure coincide with the spacing of the batteries/cells in such an array (such as a battery pack, as one example), thus permitting placement of such battery cells within cells (or, alternatively, gaps) in the honeycomb-like structure. In this manner, the resilient thermally insulating material(s) resides, ostensibly, within such cell wall formations and/or the gaps between each individual battery to provide effective thermal insulation for each individual battery therein in relation to each other individual battery. Such uniformity in honeycomb-like cell construction, separation, and constitution thereof, thus accords uniform protection throughout the entirety of the battery array from any thermal runaway caused by any individual cell itself within such an array. Likewise, the uniformity of the structure of such a thermally insulating article allows for ease in manufacturing by providing ostensibly a template for individual battery placement therein for equidistant spacing ultimately with the manufacturing capability of simply introducing each battery within each individual honeycomb-like cell quickly, safely, and reliably. The method of manufacturing such a battery array (or pack) utilizing such a thermally insulating article, not to mention the method of use thereof within an end use product housing and thus incorporating such a thermally insulating article (and battery array), are further encompassed within this disclosure as well.

As noted above, the disclosed thermally insulating article provides simultaneous benefits of proper and reliable thermal protections for each individual battery within the subject array (e.g., battery pack) and ease, simplicity, and effectiveness of reliable manufacturing of such a battery array to reduce human error and/or automated complexity thereof, as well as mechanical reinforcement of the structure and absorption of shock, vibration and other mechanical damage. Such a multi-beneficial result has not been explored within the battery industry, particularly as it concerns the capability of reducing the potential threat of thermal runaway within products including such a battery pack (array). As alluded to previously, electric vehicles (cars, bikes, etc.) have been significantly susceptible to thermal runaway challenges due to the close proximity of individual batteries to one another within such packs. Unfortunately, disastrous fires have occurred far too often in such vehicles, due primarily to manufacturing errors within even a single individual battery. A short within such a battery may generate excessive heat therein, leading to a thermal event that creates external combustion, itself creating a domino effect of thermal transfer to other adjacent batteries. Without effective thermal insulation or like protections, such a situation leads to uncontrollable thermal runaway throughout the entirety of the array causing, again, disastrous consequences. Thus, it was realized that the ability to provide effective thermal insulation through effective separation between each individual battery within such a pack was available through such a honeycomb-like structure and suitable materials utilized therein. Additionally, it was also realized that such a thermally insulating article of specific type of configuration facilitates reliable manufacturing of such a battery pack/array, as well, again benefits that have heretofore been unexplored in tandem within the battery industry.

The honeycomb-like structure itself may be described as a geometrically repetitive and preferably symmetrical configuration with preferably uniformly sized and shaped individual cells equidistant from one another with preferably uniformly structured wall formations between cell/gaps. Such cells/gaps are thus preferably uniform in size and shape as well to provide a space for introduction of individual batteries therein to the effect that the height of such wall formations is sufficiently high to ensure each such battery cell is not in contact with any other battery cell and each such battery is separated by a wall formation of a honeycomb-like cell. It should be understood that such a honeycomb-like structure must exhibit different types of cells therein in terms of external cells and interior cells since the overall structure has to exhibit exterior wall formations. As such, it should be well understood that the wall formations separating external honeycomb-like cells from interior honeycomb-like cells are to be uniform in relation to all such walls separating each honeycomb-like cell no matter the location thereof to provide the beneficial thermal insulation protections noted above as well as the ease and effectiveness of manufacture described previously. It is just noted that there will be such different types of honeycomb-like cells, but the wall formations thereof are preferably uniform throughout. In this manner, as well, the thermally insulating characteristics of the honeycomb-like structure allows for not only protections between batteries present therein, but also from the environment external to the battery array/pack and/or leading from a battery or batteries therein outside such an array to the exterior thereof.

Such a honeycomb-like configuration may thus be of any suitable repeating pattern in symmetrical formation to allow for battery placement therein each honeycomb-like cell (and height thereof to ensure, as noted above, prevention of contact between individual batteries therein or, alternatively, lack of separation of such individual batteries without thermal insulating material therebetween. Thus, geometrical shapes, particularly regular geometrical shapes such as hexagons (potentially preferred), pentagons, squares, rhombuses, triangles, may be employed as the base shape of such honeycomb-like cells (leaving openings or gaps between wall formations in such base shapes). Thus any form of two-dimensional tessellation will suffice, whether from a single shape or multiple shapes, as long as the batteries can be mapped onto the tessellation pattern. Note that all the tiles may not contain a battery, but may form an additional thermal insulation, or a space for structural members, cooling fluid, electrical connections or other pathways within the battery. The simplest of these would be a hexagonal, square or triangular symmetry, but a snub-square could provide additional spacing, insulation, or gaps for further functionality while still performing the purpose of isolating the cells electrically and thermally. The uniformity in size and shape of and distance between each honeycomb-like cell is generated through the presence of each cell exhibiting, again, the same geometric configuration, certainly. The adjacent honeycomb-like cells may be disposed in a manner that ensures uniform distance between the center of each such honeycomb-like cell as well. For instance, with hexagonally shaped honeycomb-like cells, a first column of such cells may be aligned in a straight line in one direction while the next column may be aligned at a different angle from the first column but such next (second) column remains in a straight line configuration to each cell in such a column. The third column (next after the second) may then actually exhibit the same alignment with the first column, and so on. Such alternating positions of each column (or row, for that matter) thus provides the most effective alignment overall for such a honeycomb-like article, thereby exhibiting uniformity in such a fashion as, again, preferably equidistant honeycomb-like cells are created for efficiency and, ultimately, uniformity overall. A square pattern would most likely provide a checkerboard-like structure, albeit with a three-dimensional repeating structure, thereby emulating a honeycomb-like structure as well.

The thermally insulating materials constituting such a honeycomb-like structure as disclosed herein may be of any resilient, minimally flexible, types that, as the description requires, further exhibits a suitably effective thermal insulation property. Additionally, such materials should be properly capable of being manufactured into a proper honeycomb-like structure to allow for dimensional stability to permit introduction of a plurality of batteries within each cell thereof and/or placement of such a honeycomb-like structure over such a plurality of batteries for retention thereof within an end product during use. In other words, the thermally insulating materials must be manipulatable and/or moldable (or other manufacturing procedure) into the necessary h honeycomb-like structure without losing structural capacity and capability to receive and retain the entirety of such a battery pack/array as utilized within an end product. Alternatively, again, such materials may be manufactured into such a honeycomb-like structure to then be placed over each individual battery within such a pack/array for placement within such an end product. And, certainly, as noted throughout, such manufactured a honeycomb-like article must exhibit the necessary thermal insulation properties for effective and sufficient thermal isolation (separation) of each individual battery from one another, as well.

As such, the honeycomb-like article material may be selected from any thermally stable material with a lowest melting point or thermal decomposition temperature at or above 150° C., more preferably at or above 200° C., and most preferably at or above 250° C. Such a material may be a blend of different materials that impart such a thermal decomposition temperature as noted above, as well. Such a material may be selected from different types of structures, including fiber-based types provided as woven, non-woven, knit, or other structure, as well as selected from a film, foam, and the like. Non-limiting examples include phenolic-aramid composites, phenolic glass composites, phenolic carbon fiber composites, epoxy aramid composites, epoxy-glass composites, epoxy carbon fiber composites, flame retardant plastics, aluminum, stainless steel, but other composites, high temperature plastics or metals may suffice. The metals may function primarily for electrical isolation, if coated with an insulator, and may combine the thermal insulating properties of the air gaps with thermal conduction of the metal itself to carry heat away from the batteries or connect to thermal cooling, whether passive or active, thus thermally protecting one cell from another by thermal conduction combined with the thermal insulation of the air gaps. Additionally, the honeycomb-like may be made from a thermal insulator such as a flame-retardant plastic or nonwoven which is laminated to a thermal conductor, such as aluminum sheeting. Such a honeycomb-like structure made from a layered structure would impart thermal conductivity of the heat from the battery through the metal component, potentially into a heat sink or heat conductor located above or below the array of batteries, while also imparting thermal resistance between batteries, as imparted by the flame-retardant plastic or nonwoven. Such thermally insulating (resistant) properties are exhibited by such materials, as noted herein, with the potential for a number of other beneficial properties including, without limitation, tensile strength, flame retardancy, intumescence, phase change, stiffness, bonding, binding, and thermal conductivity. A nonwoven structure may be potentially preferred, wherein a single fiber type or blend of fibers is present. As specific types of fibers, such may be selected from different types, including polyaramid, polyolefin, cellulose, asbestos, glass, carbon fibers, carbon precursor fibers, modacrylic fibers, polyphenylene-benzobisoxazole, polybenzimidazole, melamine, and other high thermal resistant fibers exhibiting a melting point or thermal decomposition point at or above 250° C., preferably at or above 300° C., and potentially most preferably at or above 350° C. High strength fibers that may be utilized herein include polyaramid, ultra-high molecular weight polyethylene, and the like. Thermal resistant fibers may include, without limitation, types such as meta-aramid, para-aramid, cellulose, asbestos, and the like. Flame retardant fibers can be any of the above, especially glass fibers and modacrylic fibers, as well as polyesters and fibers with flame retardant additives. Intumescent fibers, which expand or swell upon exposure to excess heat, include melamine fibers; phase change fibers, which exhibit the ability to absorb heat at a phase transition, include graphite-based fibers, as one example. Stiffness may be imparted by fibers such as, without limitation, fiberglass, carbon and other high modulus fibers, monofilaments or filaments with a dimension in the x-y plane that are larger than 10 microns in diameter, preferably larger than 25 microns, and most preferably larger than 50 microns. Bonding and binding fibers are generally of low-melt variety, or have a sheath with lower melting point, such that when heated they can bond two or more other fibers together, imparting strength and stiffness to the rest of the nonwoven. Thermal conductivity can be imparted with thermally conductive fibers, including metal fibers, carbon fibers, and the like. Such properties as noted above may also be imparted in terms of proper coatings applied thereto such fibers, structures, etc. Other materials may be utilized as the basis alone or in combination with those noted above as well, as the most important consideration of the honeycomb-like article is the structure thereof, the thermal insulation properties thereof, and the structural aspects thereof to permit placement of individual batteries therein in uniformly spaced fashion with protection from thermal runaway event possibilities.

As the honeycomb-like structure and battery separation issues are of primary concern (in addition to the thermal insulating properties exhibited thereby), it is noted that any type of battery that is produced or at least provided in terms of pack or array for introduction within an end product as a power source all together, may be utilized within such a thermally insulating honeycomb-like article. Type of batteries thus may be standard cylindrical structures as alkaline (AAA, AA, C, D types, for example), rechargeable lithium-ion, lithium, nickel-cadmium, sodium-ion, and other like types that may be introduced within the cells of the disclosed honeycomb-like structure. Of particular interest are cylindrical lithium-ion or lithium primary cells, which often have uniform and standard diameters such as 18 mm (18650 batteries), 21 mm (2170 batteries), 46 mm (4680, 4690 and other 46xx batteries), but of course other battery sizes and shape can be contemplated within the scope of this invention. Certainly, other battery types may be introduced within other geometric configurations as noted above to provide thermal insulation protections, as well. The size of the honeycomb-like cells may thus be targeted for specific types of batteries for introduction therein such individual cells. The batteries are best characterized by the cross-sectional dimensions that correspond to the tessellation geometry within which they fit. For a cylindrical battery, this would be the diameter. For a square or rectangular geometry, this would be the shortest axis that crosses through a geometric center of the battery, the length of the shorter side. Thus, sizes ranging from 3 millimeters (mm) to 1 meter may be implemented with the wall formations of the individual honeycomb-like cells properly provided to ensure such batteries reside safely therein such individual honeycomb-like cells during introduction as an array/pack within a target end product. The individual honeycomb-like cells should provide a snug fit for such batteries in that there is little to no movement within the honeycomb-like cells exhibited by such batteries to reduce any appreciable capability of loss of uniform disposition of such batteries within such a thermally insulating article. Thus, it should be evident that the honeycomb-like structure and thus the thermally insulating article disclosed herein may be constructed in different ways and shapes and sizes to complement the sizes and shapes of a variety of different battery types. Of particularly interest there may be cylindrical batteries that are typically present in packs for electrical vehicles (ranging from 10 mm to 1000 mm in terms of height, or preferably from 25 mm to 500 mm, or more preferably from 35 mm to 300 mm in height, and from 2 mm to 500 mm in terms of diameter, or preferably from 5 mm to 250 mm, or more preferably from 10 mm to 150 mm in diameter), utilized within cars, trucks, bicycles, scooters, and the like. For non-cylindrical batteries or other tessellation patterns, similar sizes to the diameters referred to above may in these geometries refer to the shortest length that connects two sides and passes through the geometric center of the battery (for a square or rectangle, this is the length of the shortest side; for a diamond pattern it is the distance between the closer corners; for other patterns it can be similarly found). This shortest length should therefore be between 2 mm and 500 mm, or preferably between 5 mm and 250 mm, and most preferably between 10 mm and 150 mm. For very small or very thin cells, this shortest length might be even smaller, perhaps more than 1 mm and less than 150 mm.

As alluded to above, such a disclosed thermally insulating article (honeycomb-like structure) may be constructed from a variety of different materials and thus may be manufactured in different ways and through varying means of construction. Such manufacturing alternatives include molds, presses, and the like. Two common honeycomb-like manufacturing processes are the expansion process and the corrugation process. Note that these processes, while labeled honeycomb-like, can be used to create other tessellation geometries as well.

The honeycomb-like stucture fabrication process by the expansion method begins with the stacking of sheets of the substrate material on which the adhesive node lines have been coated. The adhesive lines are then cured to form an unexpanded honeycomb-like block. The block can be expanded before curing, and then sliced, or can be sliced before being expanded. In some configurations, curing may not be necessary. The honeycomb-like structure can be expanded to regular hexagons, under expanded to six-sided diamonds, or over expanded to nearly rectangular cells. In addition, other shapes are possible depending on the number, spacing and geometry of the adhesive lines. These expanded sheets are then trimmed to the desired shape, and then fitted to the array of batteries, though these steps may be reversed. This process can be used with any sheet material as listed above, using adhesives that are appropriate for adhesion to the sheet material.

Upon manufacture thereof, such honeycomb-like structures may be transported and stored for battery pack/array construction, or may be taken directly to a location for battery implementation purposes. Again, as noted above, such a thermally insulating article may be provided with the target batteries then inserted within each honeycomb-like cell for further implementation within an end product. Alternatively, an already disposed pattern of batteries may be provided and the honeycomb-like structure may be placed thereover the plurality of batteries for introduction of such batteries within the individual honeycomb-like cells for subsequent introduction as a unit within an end product (car, bicycle, etc., as noted previously).

The full battery pack/array honeycomb-like structure thermally insulating article unit may then be monitored within the end product in some manner (utilizing sensors, for instance) for proper activity and performance therein, for instance) until there is a need for removal and possible replacement at which point the entire unit may be taken from the end product and the batteries removed therefrom. Such a honeycomb-like structure may potentially be reused if desired or, at least, the overall structure may be reclaimed and potentially recycled for another purpose. If the honeycomb-like structure comprises a thermally conductive element such as aluminum or carbon fiber, this thermally conductive element may be connected to a larger thermal conductor such as an aluminum or steel plate, or a heat sink such as any large metal object, including a battery case or other structural component.

### BRIEF DESCRIPTION OF THE DRAWINGS

FIG. 1 shows an aerial view of one potentially preferred embodiment of the description of an article exhibiting repetitive hexagonal shapes in a honeycomb-like structure.

FIG. 2 shows an isometric view of the embodiment of FIG. 1 with a plurality of batteries introduced within individual cells thereof in a suitable array and a partially removed structure for a internal perspective.

FIG. 3 shows an aerial view of another potentially preferred embodiment of the article exhibiting repetitive hexagonal and diamond shapes in a repetitive tessellation pattern.

FIG. 4 shows an aerial view of another potentially preferred embodiment of a honeycomb-like article, this one configured for housing a prismatic or pouch battery in a rectangular-shaped tessellation pattern.

FIG. 5 shows an isometric view and FIG. 5A shows an aerial view of another potentially preferred embodiment of a honeycomb-like article, this one having walls that consist of both thermally insulating and thermally conductive layers.

### DETAILED DESCRIPTION OF THE DRAWINGS AND PREFERRED EMBODIMENTS

All the features of this invention and its preferred embodiments will be described in full detail in connection with the following illustrative, but not limiting, drawings and examples.

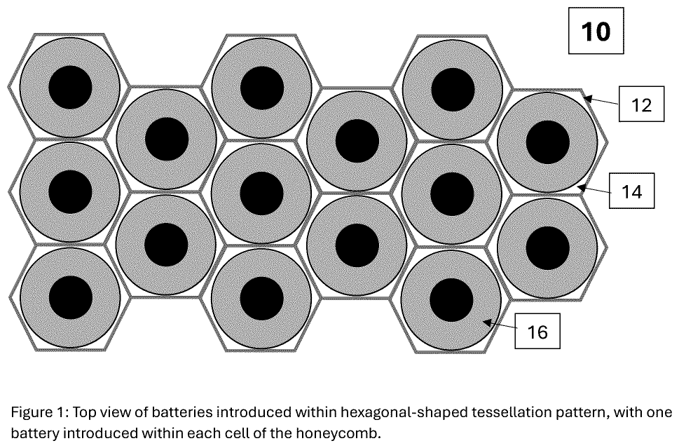

FIG. 1 shows an aerial view of a potentially preferred embodiment of a honeycomb-like structure battery array 10 including such a honeycomb-like structure (here repeating, tessellating hexagonal structures) 12 providing protection between individual battery cells (here cylindrical lithium-ion rechargeable types) 16. The honeycomb-like structure 12 is configured to house such battery cells 16 in a manner that allows for a small amount of space 14 between the batteries 16 and honeycomb-like structures 12 themselves, ostensibly to provide insulation (in tandem with the hexagonal structures 12) for the necessary temperature protections noted herein.

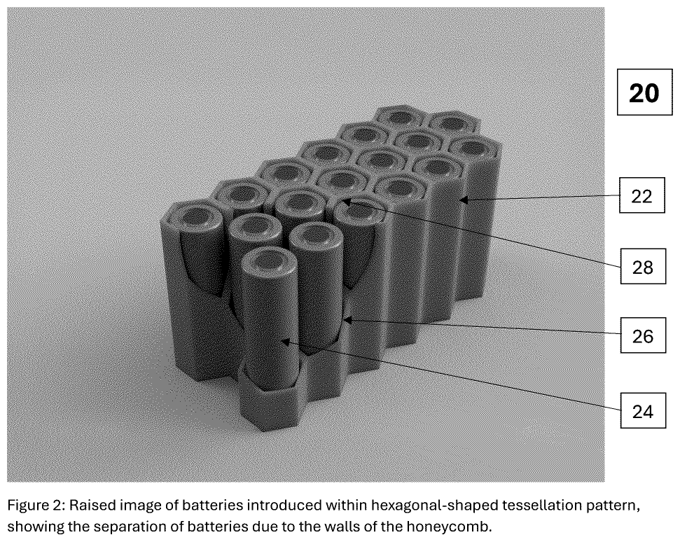

FIG. 2 shows an isometric view of a similar embodiment of a honeycomb-like structure battery array 20, albeit with a partial cutaway view 26 to provide a perspective of the battery cells 24 as present within the honeycomb-like structure 22 itself. As in FIG. 1, above, a small amount of space 28 between such battery cells 24.

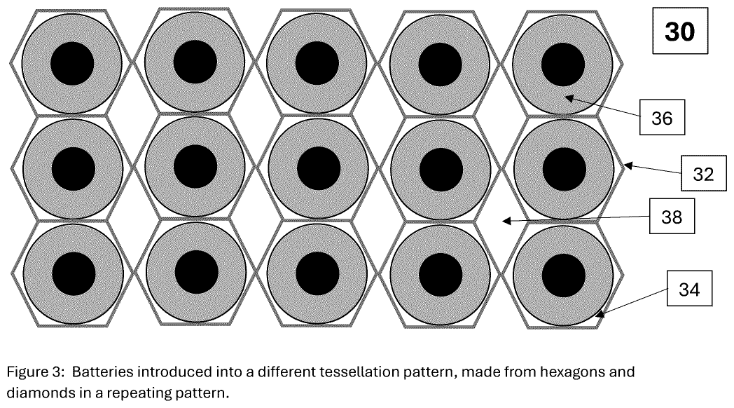

FIG. 3 shows an aerial view of another potential embodiment of a honeycomb-like structure battery array 30 exhibiting a different base structural configuration than the hexagonal tessellating one within FIGS. 1 and 2, above. In this instance, the batteries 36 are introduced within the honeycomb-like (hexagonal) cells 32; however, also present within this array 30 are rhombus- or diamond-shaped openings 38 in addition to such hexagonal types 32. Such rhombus-shaped openings 38 impart an extra layer of insulation for the array 30 (in addition to the spaces 34 between the batteries 36 and the hexagonal cells 32). Such rhombus-shaped openings 38 may actually be also utilized for battery cell placement, if desired, either in addition to the hexagonal cells 32 or as an alternative to such hexagonal cells 32. In any case, however, the ability to provide full separation of battery cells 36 within such a honeycomb-like structure 32 with such diamond cells 38 left open, allows for further capabilities such as the utilization and/or presence of cooling means (such as fluid, air flow, and/or thermally conductive materials) therein, as well as different components including, without limitation, sensors, connectors, switches, as well as other electronic or other battery components. Such a honeycomb-like structure battery array 30 thus provides significant versatility that has heretofore been unexplored within this area.

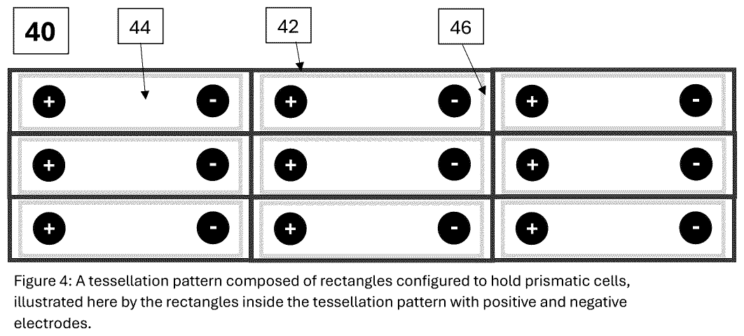

FIG. 4 shows an aerial view of another potential embodiment of a honeycomb-like structure battery array 40, in this manner one with rectangular cells 42 housing prismatic batteries 44. Spaces 46 present between the rectangular cell structures 42 and the prismatic batteries 44 allow for, as above, insulating properties (at least in terms of temperature between separated battery cells 44) in combination with the rectangular structures 42 themselves. Such an array 40 thus provides another possible geometric tessellation pattern for the disclosed device, ostensibly allowing for such battery cell 44 protections as provided above.

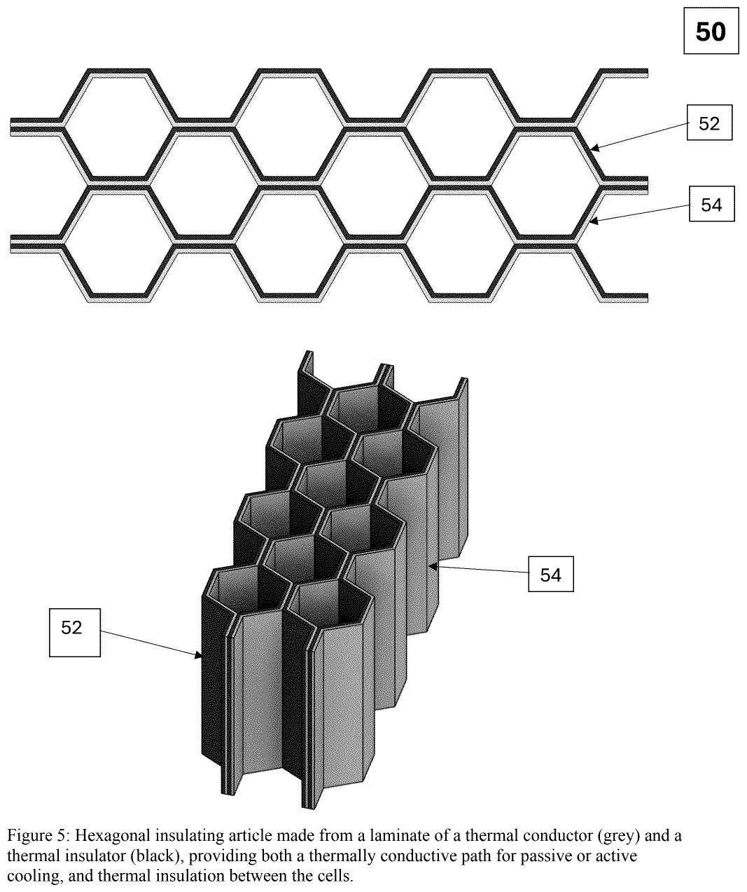

FIG. 5 shows an isometric view of another potential embodiment (and FIG. 5A provides an aerial view of the same embodiment) of a honeycomb-like structure 50 exhibiting a unique tessellation pattern (hexagonal cells) comprising different and alternating wall structures 52, 54 within the hexagonal cells 50. Such a pattern 50 includes walls (indicated as grey) that are constructed from a thermally conducting material 54 and alternating walls (indicated as black) constructed from a thermally insulating material 52. This configuration may be preferred for large batteries where both thermal insulation between the cells and also passive cooling are advantageous for both safety and thermal controls, Such alternating physical characteristics within such an array 50 may provide effects for batteries placed therein (not illustrated) including improved cycle life and improved overall electrical properties, in addition to the aforementioned safety benefits through full separation between such battery cells when present within such an array 50. It is noted that in each instance, the thermally conductive walls 54 (which may exhibit a thermal conductivity below about 0.01 Watt/meter Kelvin) and the thermally insulating walls 52 are separately present but are in contact with each alternating wall type.

### Physical Testing Examples

As nonlimiting examples, several configurations were made to show the benefits of introducing a honeycomb-like structure thermally insulating material into an array of cells.

Comparative Example 1: Three commercially available 18650 cells were placed in a linear plastic brace with 1 mm spacing between the cells, and this array was placed in a box made from cement-board. The temperature and voltage of each cell was monitored. A 10 mm square heater was placed on a cell at one end, on the side of the cell facing away from the other cells. The heater was set to maximum power, until the first cell ignited. The maximum temperature and time after ignition of the first cell to reach the maximum temperature for each cell is shown in Table 1.

Example 1: Similar to Comparative Example 1, three commercially available 18650 cells were placed in an identical array, but this time a honeycomb-like structure (as shown in FIGS. 1 and 2) made from a nonwoven comprising 80% modacrylic fibers (Keneka Protex fibers) and 20% low melt polyester fibers, needle-punched together at 250 grams/square meter, was placed over the cells such that each cell was completely encircled by the nonwoven material. The cells were similarly configured, heated, monitored and ignited as were those in Comparative Example 1. The maximum temperature and time after ignition of the first cell to reach the maximum temperature for each cell is shown in Table 1.

TABLE 1

| | Maximum | Time of maximum |
|---|---|---|
| Cell | temperature | temperature |
| Comparative Example 1, cell 1 | 1017° C. | 0 |
| Comparative Example 1, Cell 2 | 154° C. | 217 |
| Comparative Example 1, Cell 3 | 82° C. | 220 |
| Example 1, Cell 1 | 585° C. | 0 |
| Example 1, Cell 2 | 97° C. | 214 |
| Example 1, Cell 3 | 62° C. | 240 |

Thus, it can be seen that even in this limited array the maximum temperatures were significantly reduced due to the presence of the honeycomb-like structure thermally insulating material.

Comparative Example 2: In this example, nine commercially available 18650 cells were placed in a hexagonal pattern, in three rows of three with the middle row offset by one radius of the cell (9 mm), again in a plastic brace with 1 mm spacing between the cells. This array was placed into a cement-board box, and the voltage and temperature of each cell monitored while the center cell of the middle row was heated to ignition. In this example, all cells were ignited nearly simultaneously (within 10 seconds of each other), with maximum temperatures for each cell reaching between 451 and 1040° C.

Example 2: This example was constructed identically to Comparative Example 2, except that a honeycomb-like material (such as in FIGS. 1 and 2) made from the same nonwoven as in Example 1 was placed over the 18650 batteries such that each 18650 occupied one cell of the honeycomb-like material. In this example, all of the cells ignited and reached a similar temperature range to Comparative Example 1. However, the time between the first (artificially heated) cell igniting and the second cell ignited was 221 seconds, a significant delay. Such a delay, coupled with other protections including a vent port for the hot gasses to exit, could either prevent ignition of the other cells, or give passengers of a vehicle or users of a device enough time to get out of a vehicle or to safety before the entire battery pack ignites.

The utilization of the honeycomb-like material to provide a full obstruction between individual battery cells thus provided improvements to drastically reduce the propensity of cell ignition in response to high temperature exposure within such an array provides such benefits that have heretofore been unaccessible within the battery art.

It should be understood that various modifications within the scope of this disclosure can be made by one of ordinary skill in the art without departing from the spirit thereof. It is therefore wished that this disclosure be defined by the scope of the appended claims as broadly as the prior art will permit, and in view of the specification if need be.

What we claim is:

1. An article configured in a two-dimensional tessellation pattern and comprising individual cells therein that each exhibit wall formations in the third dimension therein of a generally uniform height; wherein said article provides a plurality of individual cells for introduction of individual energy storage devices within said plurality of individual cells to create an array of such individual energy storage devices thereof, wherein a plurality of individual cells exhibits a size and shape in relation to the shape and size of an individual energy storage device within said array such that the battery placed therein is separated from and not directly in contact with another energy storage device within said array.

2. The article according to claim 1 in which said wall formations comprise thermally insulating materials.

3. The article according to claim 1 in which said wall formations comprise thermally conducting materials.

4. The article according to claim 1 in which said wall formations comprise, in alternating configurations, both thermally insulating and thermally conductive materials.

5. The article according to claim 4 in which said thermally insulating and thermally conductive materials form layers that in contact with one another.

6. The article according to claim 2 in which the cell wall formations comprise materials that have a thermal conductivity below about 0.01 Watt/meter Kelvin.

7. The article according to claim 3 in which the cell wall formations comprise materials that have a thermal conductivity above about 0.1 Watt/meter Kelvin.

8. The article according to claim 1 in which the tessellation pattern comprises shapes with six sides.

9. The article according to claim 1 in which the tessellation pattern comprises shapes with four sides.

10. The article according to claim 1 in which the tessellation pattern comprises shapes with three sides.

11. The article according to claim 1 wherein said cells are polygonal cells.

12. The article according to claim 11 wherein said polygonal cells are regular polygonal cells.

13. The article according to claim 11 wherein said polygonal cells are selected from the group consisting of hexagons, pentagons, squares and triangles.

14. The article according to claim 13 wherein said polygonal cells are hexagons.

15. The article according to claim 1 wherein said article comprises a material selected from the group consisting of any thermally stable material with a lowest melting point or thermal decomposition temperature at or above 150° C.

16. The article according to claim 15 wherein said thermally stable material is selected from the group consisting of fiber-based materials provided as woven, non-woven, knit, or other structure, as well as selected from a film, foam, and any combinations thereof.

17. A method of manufacturing a battery pack utilizing the thermally insulating article of claim 1, said method comprising the sequential steps of:
i) providing said thermally insulating article;
ii) introducing individual batteries of the same size and shape within said individual cells thereof said thermally insulating article such that said individual batteries introduced therein form a unitary structure of individual batteries within said individual cells of said thermally insulating article; and
iii) introducing said unitary structure within an electrical end product wherein said individual batteries provide said end product a power source for operation thereof.

18. A method of manufacturing a battery pack utilizing the thermally insulating article of claim 2, said method comprising the sequential steps of:
i) providing said thermally insulating article;
ii) introducing individual batteries of the same size and shape within said individual cells thereof said thermally insulating article such that said individual batteries introduced therein form a unitary structure of individual batteries within said individual cells of said thermally insulating article; and
iii) introducing said unitary structure within an electrical end product wherein said individual batteries provide said end product a power source for operation thereof.

19. A method of manufacturing a battery pack utilizing the thermally insulating article of claim 3, said method comprising the sequential steps of:
i) providing said thermally insulating article;
ii) introducing individual batteries of the same size and shape within said individual cells thereof said thermally insulating article such that said individual batteries introduced therein form a unitary structure of individual batteries within said individual cells of said thermally insulating article; and
iii) introducing said unitary structure within an electrical end product wherein said individual batteries provide said end product a power source for operation thereof.

20. A method of manufacturing a battery pack utilizing the thermally insulating article of claim 4, said method comprising the sequential steps of:
i) providing said thermally insulating article;
ii) introducing individual batteries of the same size and shape within said individual cells thereof said thermally insulating article such that said individual batteries introduced therein form a unitary structure of individual batteries within said individual cells of said thermally insulating article; and
iii) introducing said unitary structure within an electrical end product wherein said individual batteries provide said end product a power source for operation thereof.

21. A method of manufacturing a battery pack utilizing the thermally insulating article of claim 5, said method comprising the sequential steps of:
i) providing said thermally insulating article;
ii) introducing individual batteries of the same size and shape within said individual cells thereof said thermally insulating article such that said individual batteries introduced therein form a unitary structure of individual batteries within said individual cells of said thermally insulating article; and
iii) introducing said unitary structure within an electrical end product wherein said individual batteries provide said end product a power source for operation thereof.

22. A method of manufacturing a battery pack utilizing the thermally insulating article of claim 6, said method comprising the sequential steps of:
i) providing said thermally insulating article;
ii) introducing individual batteries of the same size and shape within said individual cells thereof said thermally insulating article such that said individual batteries introduced therein form a unitary structure of individual batteries within said individual cells of said thermally insulating article; and
iii) introducing said unitary structure within an electrical end product wherein said individual batteries provide said end product a power source for operation thereof.

23. A method of manufacturing a battery pack utilizing the thermally insulating article of claim 7, said method comprising the sequential steps of:
i) providing said thermally insulating article;
ii) introducing individual batteries of the same size and shape within said individual cells thereof said thermally insulating article such that said individual batteries introduced therein form a unitary structure of individual batteries within said individual cells of said thermally insulating article; and
iii) introducing said unitary structure within an electrical end product wherein said individual batteries provide said end product a power source for operation thereof.

24. A method of manufacturing a battery pack utilizing the thermally insulating article of claim 8, said method comprising the sequential steps of:
i) providing said thermally insulating article;
ii) introducing individual batteries of the same size and shape within said individual cells thereof said thermally insulating article such that said individual batteries introduced therein form a unitary structure of individual batteries within said individual cells of said thermally insulating article; and
iii) introducing said unitary structure within an electrical end product wherein said individual batteries provide said end product a power source for operation thereof.

25. A method of manufacturing a battery pack utilizing the thermally insulating article of claim 9, said method comprising the sequential steps of:
i) providing said thermally insulating article;
ii) introducing individual batteries of the same size and shape within said individual cells thereof said thermally insulating article such that said individual batteries introduced therein form a unitary structure of individual batteries within said individual cells of said thermally insulating article; and
iii) introducing said unitary structure within an electrical end product wherein said individual batteries provide said end product a power source for operation thereof.

26. A method of manufacturing a battery pack utilizing the thermally insulating article of claim 10, said method comprising the sequential steps of:
i) providing said thermally insulating article;
ii) introducing individual batteries of the same size and shape within said individual cells thereof said thermally insulating article such that said individual batteries introduced therein form a unitary structure of individual batteries within said individual cells of said thermally insulating article; and
iii) introducing said unitary structure within an electrical end product wherein said individual batteries provide said end product a power source for operation thereof.

27. A method of manufacturing a battery pack utilizing the thermally insulating article of claim 11, said method comprising the sequential steps of:
i) providing said thermally insulating article;
ii) introducing individual batteries of the same size and shape within said individual cells thereof said thermally insulating article such that said individual batteries introduced therein form a unitary structure of individual batteries within said individual cells of said thermally insulating article; and
iii) introducing said unitary structure within an electrical end product wherein said individual batteries provide said end product a power source for operation thereof.

28. A method of manufacturing a battery pack utilizing the thermally insulating article of claim 12, said method comprising the sequential steps of:
i) providing said thermally insulating article;
ii) introducing individual batteries of the same size and shape within said individual cells thereof said thermally insulating article such that said individual batteries introduced therein form a unitary structure of individual batteries within said individual cells of said thermally insulating article; and
iii) introducing said unitary structure within an electrical end product wherein said individual batteries provide said end product a power source for operation thereof.

29. A method of manufacturing a battery pack utilizing the thermally insulating article of claim 13, said method comprising the sequential steps of:
i) providing said thermally insulating article;
ii) introducing individual batteries of the same size and shape within said individual cells thereof said thermally insulating article such that said individual batteries introduced therein form a unitary structure of individual batteries within said individual cells of said thermally insulating article; and
iii) introducing said unitary structure within an electrical end product wherein said individual batteries provide said end product a power source for operation thereof.

30. A method of manufacturing a battery pack utilizing the thermally insulating article of claim 14, said method comprising the sequential steps of:
i) providing said thermally insulating article;
ii) introducing individual batteries of the same size and shape within said individual cells thereof said thermally insulating article such that said individual batteries introduced therein form a unitary structure of individual batteries within said individual cells of said thermally insulating article; and
iii) introducing said unitary structure within an electrical end product wherein said individual batteries provide said end product a power source for operation thereof.

31. A method of manufacturing a battery pack utilizing the thermally insulating article of claim 15, said method comprising the sequential steps of:
i) providing said thermally insulating article;
ii) introducing individual batteries of the same size and shape within said individual cells thereof said thermally insulating article such that said individual batteries introduced therein form a unitary structure of individual batteries within said individual cells of said thermally insulating article; and
iii) introducing said unitary structure within an electrical end product wherein said individual batteries provide said end product a power source for operation thereof.

32. A method of manufacturing a battery pack utilizing the thermally insulating article of claim 16, said method comprising the sequential steps of:
i) providing said thermally insulating article;
ii) introducing individual batteries of the same size and shape within said individual cells thereof said thermally insulating article such that said individual batteries introduced therein form a unitary structure of individual batteries within said individual cells of said thermally insulating article; and
iii) introducing said unitary structure within an electrical end product wherein said individual batteries provide said end product a power source for operation thereof.
